(19) United States
(12) Patent Application Publication
(10) Pub. No.: US 2011/0099041 A1
(43) Pub. Date: Apr. 28, 2011

(54) Method And System For Allocating Personnel Resources

(76) Inventors: Ghulam LALJIANI, Duluth, GA (US); Donna B. DENNING, Smyrna, GA (US); Bryan McMILLAN, Peachtree City, GA (US)

(21) Appl. No.: 12/603,848

(22) Filed: Oct. 22, 2009

(51) Int. Cl. G06Q 10/00; G06F 17/30; G06Q 50/00

(52) U.S. Cl. 705/7.17; 707/769; 705/301; 705/32; 707/E17.014

(57) ABSTRACT

A computer readable storage medium storing a set of instructions executable by a processor, the instructions being operable to receive data about a plurality of employees, the data including an employee time commitment for each of the employees, the data further including an employee qualification for each of the employees; classify the received data as a function of a project to which each of the employees is assigned, wherein the data is further classified as a function of a supervisor of each of the employees; receive a query from a user, the query being directed to a time usage of one of the employees, the query specifying an attribute of the user; and provide a result of the query to the user, the result relating to the attribute, the result including one of a discipline of the user, an area of expertise of the user, an employee status of the user, a project involvement of the user, a job title of the user, and a work expended of the user.

### BACKGROUND

Businesses may need to maintain records of the qualifications and availability of their employees. This recordkeeping may become challenging and time-consuming for businesses with large numbers of employees. Further, staffing changes and requirements may shift and thus require constant and up-to-date monitoring.

### SUMMARY OF THE INVENTION

A computer readable storage medium storing a set of instructions executable by a processor, the instructions being operable to receive data about a plurality of employees, the data including an employee time commitment for each of the employees, the data further including an employee qualification for each of the employees; classify the received data as a function of a project to which each of the employees is assigned, wherein the data is further classified as a function of a supervisor of each of the employees; receive a query from a user, the query being directed to a time usage of one of the employees, the query specifying an attribute of the user; and provide a result of the query to the user, the result relating to the attribute, the result including one of a discipline of the user, an area of expertise of the user, an employee status of the user, a project involvement of the user, a job title of the user, and a work expended of the user.

A system having a memory and a processor, the processor being configured to receive data about a plurality of employees, the data including an employee time commitment for each of the employees, the data further including an employee qualification for each of the employees; classify the received data as a function of a project to which each of the employees is assigned, wherein the data is further classified as a function of a supervisor of each of the employees; receive a query from a user, the query being directed to a time usage of one of the employees, the query specifying an attribute of the user; and provide a result of the query to the user, the result relating to the attribute, the result including one of a discipline of the user, an area of expertise of the user, an employee status of the user, a project involvement of the user, a job title of the user, and a work expended of the user.

A system having means for receiving data about a plurality of employees, the data including an employee time commitment for each of the employees, the data further including an employee qualification for each of the employees; means for classifying the received data as a function of a project to which each of the employees is assigned, wherein the data is further classified as a function of a supervisor of each of the employees; means for receiving a query from a user, the query being directed to a time usage of one of the employees, the query specifying an attribute of the user; and means for providing a result of the query to the user, the result relating to the attribute, the result including one of a discipline of the user, an area of expertise of the user, an employee status of the user, a project involvement of the user, a job title of the user, and a work expended of the user.

### BRIEF DESCRIPTION OF THE DRAWINGS

FIG. 1 shows an exemplary method according to the present invention.

FIG. 2 shows an exemplary system for implementing the exemplary method of FIG. 1 according to the present invention.

FIG. 3 shows an exemplary display of results to a user as provided by the system of FIG. 2 and the method of FIG. 1.

FIG. 4 shows a further exemplary display of results to a user as provided by the system of FIG. 2 and the method of FIG. 1.

FIG. 5 shows a further exemplary display of results to a user as provided by the system of FIG. 2 and the method of FIG. 1.

### DETAILED DESCRIPTION

The exemplary embodiments of the present invention may be further understood with reference to the following description and the appended drawings, wherein like elements are referred to with the same reference numerals. The exemplary embodiments describe systems and methods for providing data concerning staff qualifications and availability to employers.

Organizations employing large numbers of people may need to maintain and provide to management large amounts of data about employees. This may include employee availability at various dates, employee disciplines, specific employee qualifications, areas of expertise, types of employment, etc.

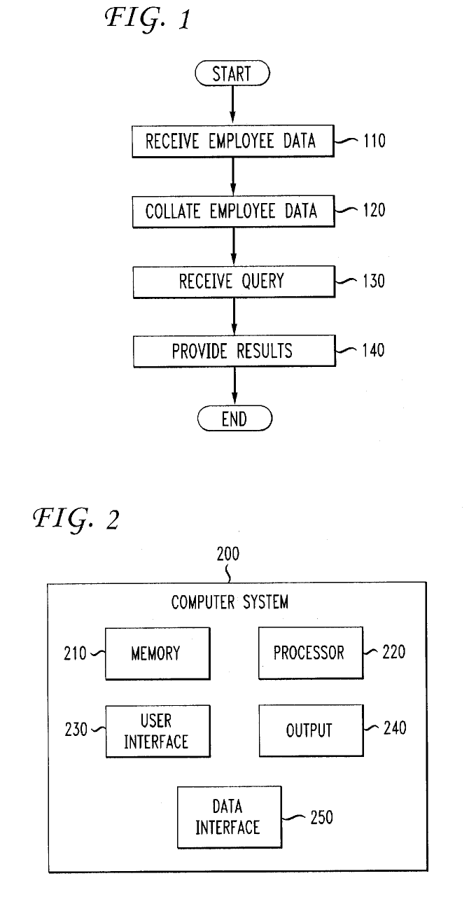

FIG. 1 presents an exemplary method for recording and presenting employee data according to the present invention. In step 110, various data about employee qualifications are received. The data may be manually entered (e.g., using the user interface 230 of the system 200), though in a preferred embodiment it may be received from an employee database, such as may be maintained by a human resources department. The data may pertain to all employees of a business, or it may pertain to one or more subsets of employees (e.g., one particular department, a plurality of departments, part-time employees only, etc.).

The data may include, for each employee, current work commitments, future work commitments, and information about the employee's qualifications. Qualification information may include the employee's discipline. For an information technology employee, the employee may be, for example, a project manager, a solutions architect, a requirements lead, a developer, a quality control tester, a release manager, a database administrator, etc. For an employee in a different field, the discipline may vary correspondingly. Discipline information may also include one or more alternate/secondary roles for each employee (e.g., if a project manager may alternately be capable of functioning as a release manager, etc.), where appropriate. In one exemplary embodiment, up to two secondary roles may be provided for each employee.

The data may also include one or more areas of expertise for each employee. Continuing with the example of an information technology employee, these may include Java, WebLogic GUI, Fault Management, Service Order Management, Network Creation, Topology, Configuration Management, etc. As above, the specific areas of expertise may vary depending on the type of employees being presented by the data. In one exemplary embodiment, up to five areas of expertise may be provided for each employee.

The data may also include the employee's staffing status (e.g., full-time, part-time, contractor, consultant, etc.). The data may also include the employee's job title, supervisor or supervisors, or any further data available concerning the scope of the employee's employment or qualifications. Data may be received from a single source or from multiple sources. In one example, data may be received from a first source providing information about employee qualifications and a second source providing information about employee time commitments.

In step 120, all received data is processed and collated. This step may occur periodically at set time intervals, or may occur continuously as new data is received from various sources. In some embodiments, data may be “pushed” from sources and processed as it is received. Data may be processed such that all data pertaining to a particular employee is linked to the identity of the employee. During this collation process, employee data maybe processed using various algorithms to compute workload, availability, percentage of project assignment, total hours already consumed, remaining estimated workload hours, administrative load, etc.

In step 130, a user submits a query requesting information. Such a query might be structured either broadly (e.g., a request to see all staff who are uncommitted on a specified future date, a request to see all staff with a particular qualification, etc.) or narrowly (e.g., show staff allocated to work with a specified manager on a specified project, etc.). In one embodiment, data pertaining to each relevant employee may be retrieved based on a unique identifier for the employee, such as by a user ID. The query may be submitted, for example, by activating a previously defined procedure that is adapted to provide the user with a particular desired type or view of result data. In a preferred embodiment, the user may have a plurality of such procedures available to choose from, in order to be able to easily request and receive various types and views of results. In step 140, the results of the query are provided to the user. The results may be provided, for example, in a view corresponding to a search procedure selected by the user in step 130. Results may include both textual/numerical results and graphical representations of such results (e.g., bar graphs). A set of formal reports based on pivot data tables exists and may be provided. Users can extend these existing reports or create new reports based on user selectable criteria with existing data fields.

FIG. 2 illustrates a schematic view of a computer system 200 that may perform the exemplary method 100, as described above. The system 200 may include a memory 210 that may store a program embodying the method 100. The memory 210 may be, for example, a hard drive, a CD-ROM storage, etc. The system 200 may further include a processor 220, a user interface 230, and an output 240. The processor 210 may be any of the various processors known in the art and suitable for performing the exemplary method 100. The user interface 230 may include a keyboard, a mouse, a touch-sensitive display, or any other mechanism by which a user may provide input. The output 240 may include a monitor, a printer, or any other mechanism by which results of the method 100 may be provided to a user. The system may further include a data interface 250, which may receive input data from external sources such as databases, as described above with reference to step 110.

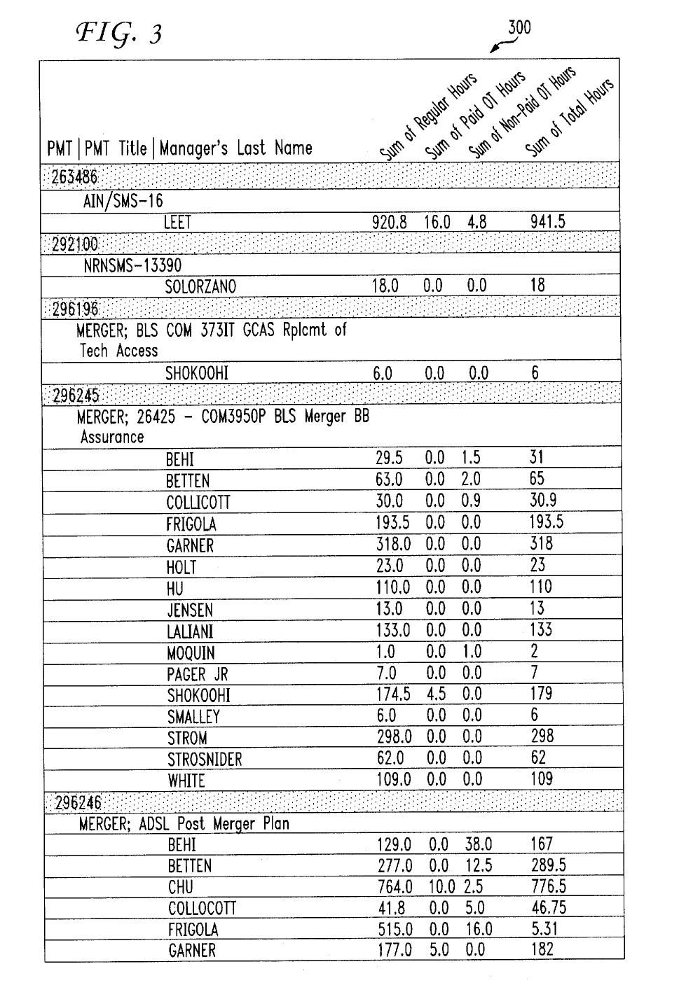

FIG. 3 illustrates an exemplary set of results 300 as provided to a user by the method 100, such as via the output 240 of the system 200. In the set of results 300 illustrated in FIG. 3, employees are classified by projects they have worked on and/or are currently assigned to and working on; hours worked on the specified projects are provided. The hours are further broken down into regular hours, paid overtime hours, and non-paid overtime hours. The results may include actual time spent by employees, as well as estimated usage that may have been previously determined by a manager; by providing both actual usage and previous estimates, reconciliation may be performed, such as on a monthly basis. The manager may also enter projections for future usage in order to determine staffing levels prior to beginning a new project.

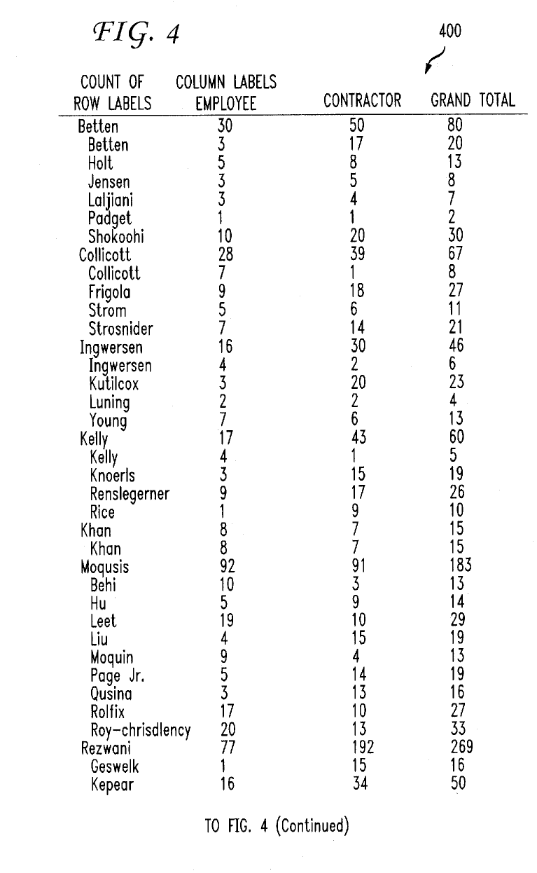

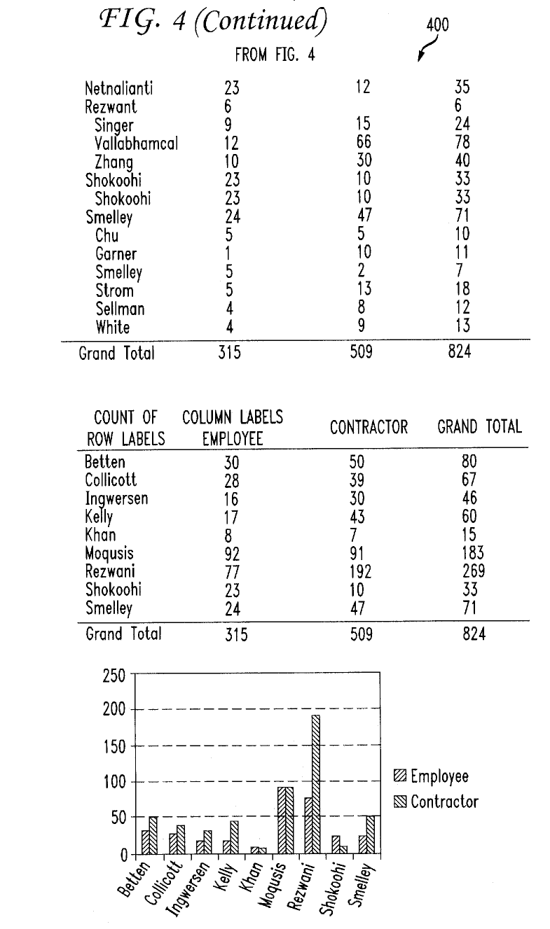

FIG. 4 illustrates a further exemplary set of results 400 as provided to a user by the method 100, such as via the output 240 of the system 200. In the set of results 400 illustrated in FIG. 4, two tiers of management are shown. Lower-level managers, whose names are indented, are shown together with total numbers of employees and contractors directly under their supervision. Top-level managers, whose names are left-justified, are shown together with total numbers of employees indirectly under their supervision; these numbers are the sum of those of the managers whom they supervise. A summary view for top-level managers and a corresponding bar graph are also provided in the right column.

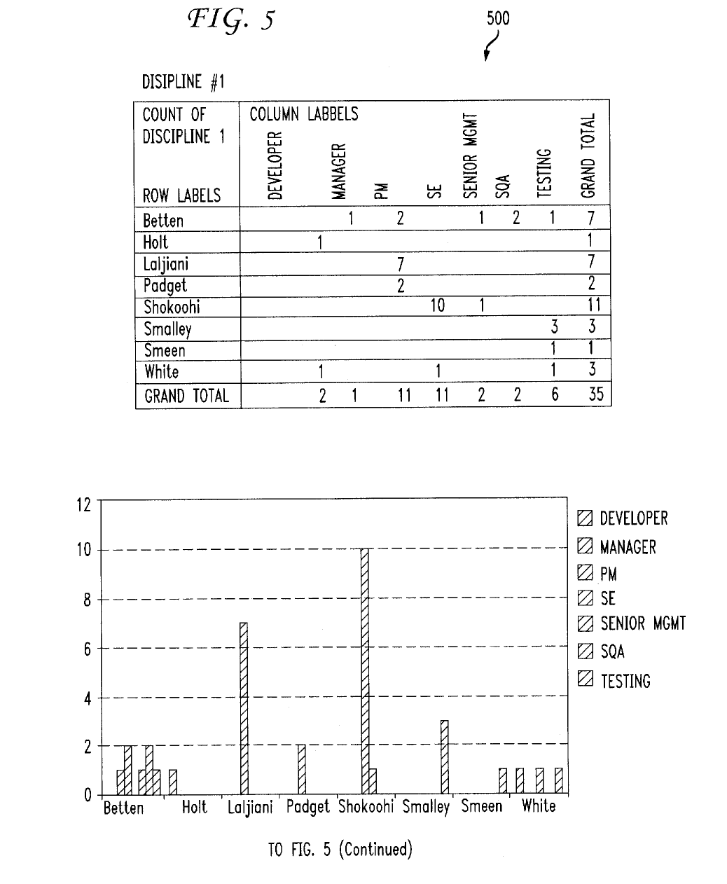

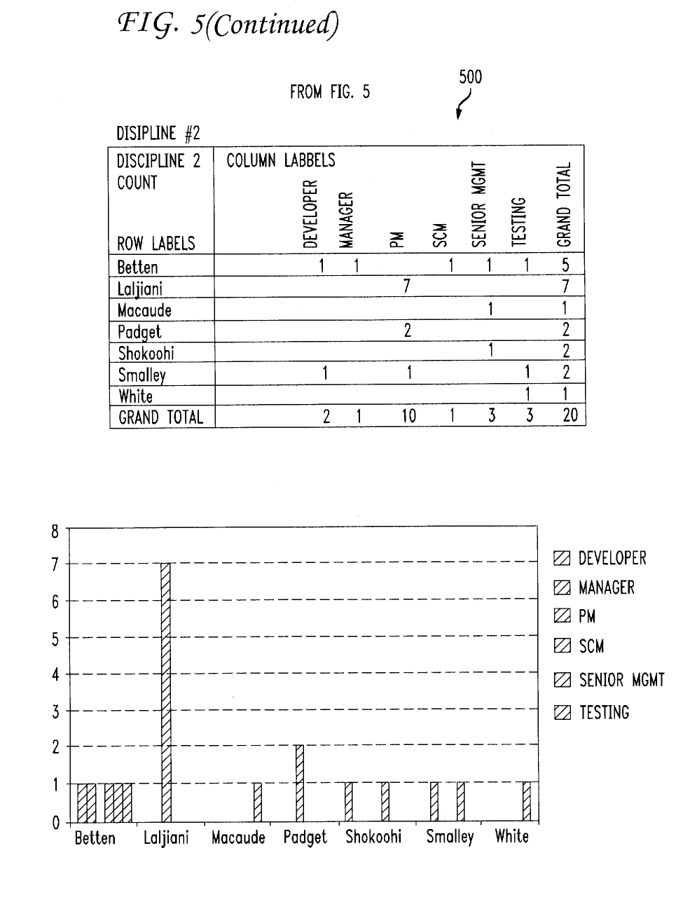

FIG. 5 illustrates a further exemplary set of results 500 as provided to a user by the method 100, such as via the output 240 of the system 200. In the set of results 500 illustrated in FIG. 5, employees are classified by discipline. In this context, a “discipline” is a distinct individual capability or skill set offered, such as a C++ Developer, Mid-Level Manager, GUI Developer, System Tester, etc. This relates to the employee's abilities and does not necessary equate to the role to which they are currently assigned. For each of two disciplines, a count is provided for employees with specific roles (e.g., developer, manager, etc.) working for each of a list of managers. For example, in the chart labeled “Discipline #2”, it can be seen that manager Betten supervises one developer, one manager, one software configuration management (“SCM”) employee, one senior manager and one testing employee, all of whom may be presumed to be skilled in Discipline #2. Corresponding bar graphs may also be provided to the user. As future employee commitments are made, a manager may also determine an earliest availability for an employee to fill a staffing requirement by searching for a month in which an employee satisfying that requirement has less than a full scheduled work load.

Those of skill in the art will understand that the sets of results 300, 400 and 500 provided in FIGS. 3, 4, and 5, respectively, are only exemplary and that other types or other formats of results may also be provided by the method 100 and the system 200. The exemplary embodiments may thus provide information about staffing and availability to users in a more reliable, convenient and up-to-date manner than has been available using prior methods.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A computer readable storage medium storing a set of instructions executable by a processor, the instructions being operable to:
receive data about a plurality of employees, the data including an employee time commitment for each of the employees, the data further including an employee qualification for each of the employees;
classify the received data as a function of a project to which each of the employees is assigned, wherein the data is further classified as a function of a supervisor of each of the employees;
receive a query from a user, the query being directed to a time usage of one of the employees, the query specifying an attribute of the user; and
provide a result of the query to the user, the result relating to the attribute, the result including one of a discipline of the user, an area of expertise of the user, an employee status of the user, a project involvement of the user, a job title of the user, and a work expended of the user.

2. The computer readable storage medium of claim 1, wherein the data is received from a plurality of sources.

3. The computer readable storage medium of claim 1, wherein the data further includes an identity of a supervisor for each of the employees.

4. The computer readable storage medium of claim 1, wherein the query is directed to a time commitment of a plurality of the employees.

5. The computer readable storage medium of claim 4, wherein the plurality of the employees is a plurality of the employees having one of a common supervisor and a common discipline.

6. The computer readable storage medium of claim 1, wherein the time commitment is one of a past time commitment, a present time commitment, and a future time commitment.

7. The computer readable storage medium of claim 1, wherein the result is provided as one of a textual representation and a graphical representation.

8. The computer readable storage medium of claim 1, wherein the work expended includes one of regular hours and overtime hours.

9. The computer readable storage medium of claim 8, wherein the regular hours and the overtime hours are classified by a supervisor of the one of the employees.

10. The computer readable storage medium of claim 1, wherein the employee status is one of an employee, a contractor and a consultant.

11. A system, comprising:
a memory; and
a processor configured to receive data about a plurality of employees, the data including an employee time commitment for each of the employees, the data further including an employee qualification for each of the employees; classify the received data as a function of a project to which each of the employees is assigned, wherein the data is further classified as a function of a supervisor of each of the employees; receive a query from a user, the query being directed to a time usage of one of the employees, the query specifying an attribute of the user; and provide a result of the query to the user, the result relating to the attribute, the result including one of a discipline of the user, an area of expertise of the user, an employee status of the user, a project involvement of the user, a job title of the user, and a work expended of the user.

12. The system of claim 11, wherein the data is received from a plurality of sources.

13. The system of claim 11, wherein the data further includes an identity of a supervisor for each of the employees.

14. The system of claim 11, wherein the query is directed to a time commitment of a plurality of the employees.

15. The system of claim 14, wherein the plurality of the employees is a plurality of the employees having one of a common supervisor and a common discipline.

16. The system of claim 11, wherein the time commitment is one of a past time commitment, a present time commitment, and a future time commitment.

17. The system of claim 11, wherein the result is provided as one of a textual representation and a graphical representation.

18. The system of claim 11, wherein the work expended includes one of regular hours and overtime hours.

19. The system of claim 18, wherein the regular hours and the overtime hours are classified by a supervisor of the one of the employees.

20. A system, comprising:
means for receiving data about a plurality of employees, the data including an employee time commitment for each of the employees, the data further including an employee qualification for each of the employees;
means for classifying the received data as a function of a project to which each of the employees is assigned, wherein the data is further classified as a function of a supervisor of each of the employees;
means for receiving a query from a user, the query being directed to a time usage of one of the employees, the query specifying an attribute of the user; and
means for providing a result of the query to the user, the result relating to the attribute, the result including one of a discipline of the user, an area of expertise of the user, an employee status of the user, a project involvement of the user, a job title of the user, and a work expended of the user.
